(19) United States
(12) Patent Application Publication
(10) Pub. No.: US 2003/0021376 A1
(43) Pub. Date: Jan. 30, 2003

(54) High-resolution radiation detector

(76) Inventor: Steven Winn Smith, Poway, CA (US)

Correspondence Address: Steven W. Smith, Spectrum San Diego, Inc., 15950 Bernardo Center Dr. Ste. N, San Diego, CA, 92127, US

(21) Appl. No.: 10/184,125

(22) Filed: Jun. 28, 2002

Related U.S. Application Data
(60) Provisional application No. 60/307,657, filed on Jul. 26, 2001.

(51) Int. Cl. H05G 1/64

(52) U.S. Cl. 378/98.8

(57) ABSTRACT

A high-resolution radiation detector is formed by viewing a scintillation crystal with an electronic camera through an optical lens assembly. The material of the scintillation crystal is selected to have a high density, contain a high atomic number element, and have a high index of refraction, such as Bismuth Germinate Oxide, Cadmium Tungstate, or Gadolinium Silicate. A light absorbing coating is applied to the radiation entry surface of the scintillation crystal to further increase the spatial resolution of the detector. In some embodiments of the invention, the optical lens assembly has a large f-number, providing further improvements in spatial resolution.

This invention was made with Government support under grant DMI-0091519 awarded by the National Science Foundation. The Government has certain rights in this invention.

### BACKGROUND OF THE INVENTION

This Invention relates to the acquisition of x-ray images and particularly to electronic x-ray imaging detectors exhibiting a high spatial resolution.

It is a common need in nondestructive testing and other areas of science and engineering to examine very small objects using x-ray irradiation. One example of this is the inspection of the solder connections of electronic assemblies to insure that they have been properly fabricated. This frequently involves objects as small as 100 microns or less, thereby requiring an x-ray imaging system with a spatial resolution of 5-10 microns.

Prior art electronic x-ray imaging detectors operate by converting the incoming pattern of x-rays into a corresponding pattern of visible light through the use of a scintillation screen or crystal. This visible light image is then converted into an electronic signal by a video camera. The primary factors limiting the spatial resolution of this detector configuration are (1) the characteristics of the scintillation material and (2) the geometry of the optical assemblies used to transfer light from the scintillation crystal to the video camera. These factors limit prior art detectors from achieving a spatial resolution better than 50-100 microns.

In one prior art approach, a microfocus x-ray source is used in conjunction with magnification radiography to compensate for the insufficient resolution of the detector. This involves placing the object being inspected much closer to the x-ray source than the detector, resulting in the x-ray image of the object being geometrically magnified before striking the detector. If enough magnification is used, the overall spatial resolution of the system is limited by the size of the x-ray focal spot, and not by the resolution of the detector. Commercially available microfocus x-ray sources have focal spots of 5-10 microns is size, thereby providing systems with spatial resolutions of 5-10 microns. However, this approach has many disadvantages. Magnification radiography inherently produces different magnification factors at different distances from the x-ray source. This results in geometric distortion between the side of an object that is closest to the x-ray source, and the side that is farthest away. This makes it difficult or impossible to determine a spatial calibration in the acquired image, as well as complicating the task of image analysis. In addition, microfocus x-ray sources are more complicated and difficult to use than x-ray sources with larger focal spots, and have far lower x-ray output levels.

As thus shown, prior art x-ray imaging systems operating without magnification radiography have poor resolution. On the other hand, prior art systems using magnification radiography have geometric distortion and various problems associated with the use of microfocus x-ray sources. What is needed is a an improved x-ray detector capable of 5-10 micron resolution, thereby providing a high-resolution imaging system without geometric distortion nor the need to use a microfocus x-ray source.

### BRIEF SUMMARY OF THE INVENTION

The present Invention provides an electronic x-ray imaging detector with improved resolution over prior art systems. This is achieved through the use of a scintillation crystal for converting the x-ray image into a visible light image, and a lens assembly relaying the light image to an electronic camera. The scintillation crystal is distinguished from the prior art in that it is transparent, dense, contains one or more high atomic number elements, has a high index of refraction, and has a blackened x-ray entry surface. Also in one or more embodiments, the lens assembly is distinguished from the prior art in that it has a large f-number.

It is the goal of the Invention to provide an x-ray detector with improved spatial resolution. Another goal of the Invention is to provide an x-ray detector that eliminates the need to use magnification radiography with its associated geometric distortion. Still another goal is to enable high resolution x-ray imaging without the use of microfocus x-ray sources.

### BRIEF DESCRIPTION OF THE DRAWINGS

FIG. 1 is a schematic depiction of the Invention.

FIGS. 2A and 2B are schematic depictions in accordance with the Invention, illustrating the light paths through the various components.

FIGS. 3A, 3B, 3C and 3D are schematic depictions in accordance with the Invention, illustrating the resolution limiting mechanisms.

FIG. 4 is a graph in accordance with the Invention, illustrating the dependence of resolution on f-number and scintillation material.

### DETAILED DESCRIPTION OF THE INVENTION

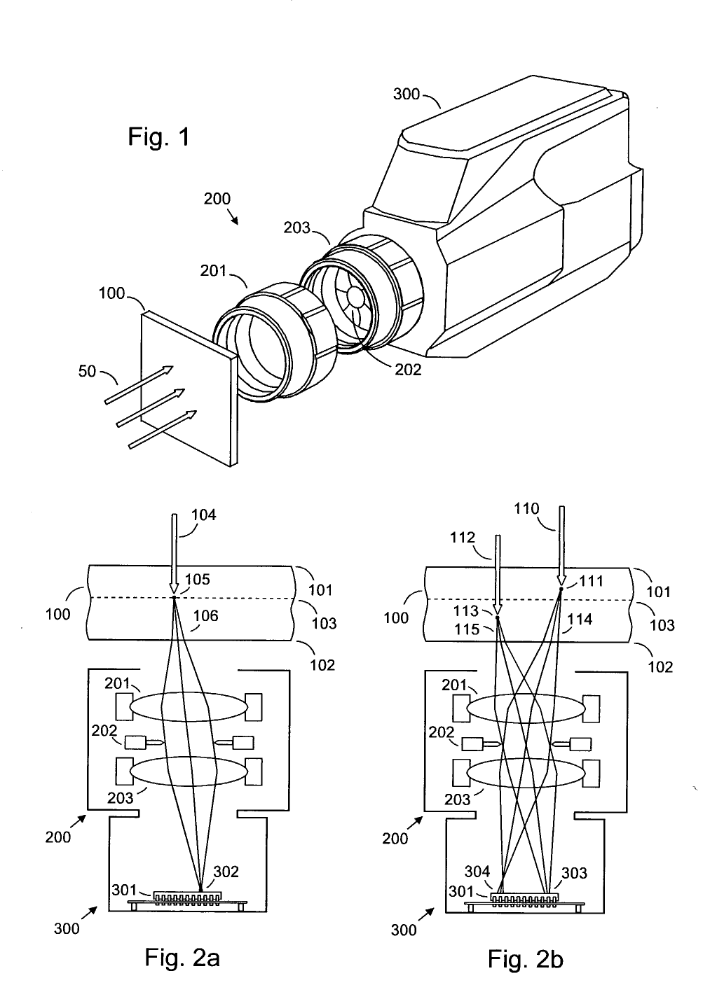

FIG. 1 shows the components of the Invention. A two-dimensional pattern of x-rays 50 impinge on a transparent scintillation crystal 100. The resulting optical image is transferred to electronic camera 300 by lens assembly 200, consisting of collimating lens 201, focusing lens 203, and aperture 202. As can be appreciated by those skilled in the art, this configuration allows the two-dimensional pattern of x-rays 50 to be converted into an electronic image for visual display or digitization into a computer system. This technique of using an electronic camera, lens assembly, and scintillation crystal to detect an x-ray image is well known in the art, such as described in U.S. Pat. Nos. 3,790,785 and 5,723,865.

FIG. 2A further illustrates the operation of the Invention, showing a ray tracing of the light paths from the scintillation crystal 100, through the lens assembly 200, and into the camera 300. A single x-ray photon 104 (one of the many x-ray photons in the x-ray beam 50), enters the scintillation crystal 100 through the front crystal surface 101 and interacts at location 105. This results in several hundred or thousand visible light photons 106 being emitted from location 105, exiting the scintillation crystal 100 through the rear surface 102, and being captured by the lens assembly 200. Since the location of interaction 105 is situated on the focal plane 103 of the lens assembly 200, all of the light 106 is focused to a single point 302 on the camera's image sensor 301. This is a case of perfect focusing, where the single interaction 105 results in an single point of illumination 302 on the image sensor 301.

FIG. 2B is a modification of FIG. 2A, illustrating the effect of x-rays interacting in the scintillation crystal 100 at locations other than on the focal plane 103. Two examples are shown in FIG. 2B. In the first example, a single x-ray 112 (one of the many x-ray photons in the x-ray beam 50) interacts at location 113, which is farther from the entry surface 101 than the focal plane 103. This results in a cone of light photons 115 passing through the lens assembly 200 and being partially focused on the image sensor 301 at location 303. Since the location of interaction 113 is not on the focal plane 103, the resulting pattern of light at location 303 will be a blur, and not a sharp point of light. In this same manner, another single x-ray 110 interacts at location 111, which is closer to the entry surface 101 than the focal plane 103. This results in the cone of light 114 also being focused to a blur at location 304 on the image sensor 301.

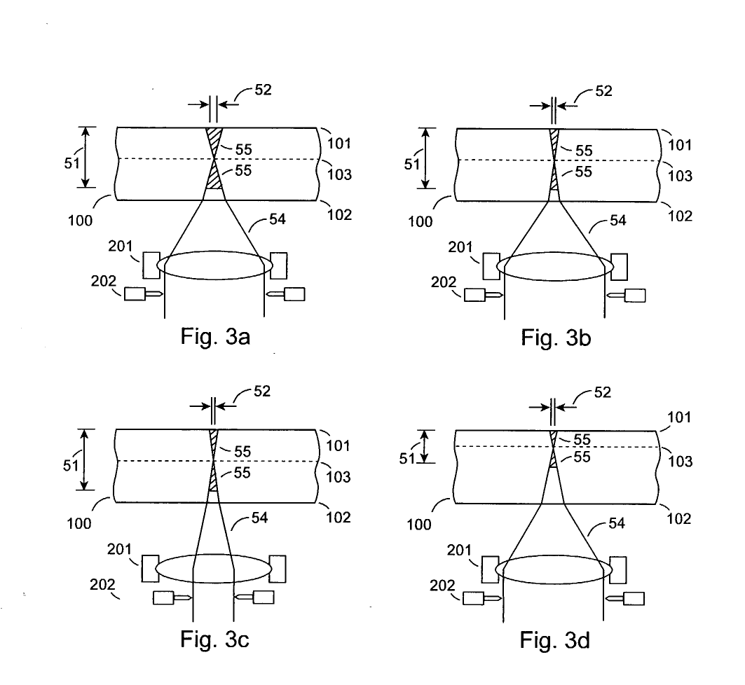

FIGS. 2A and 2B illustrate that x-rays interacting at different depths within the scintillation crystal 100, relative to the focal plane 103, produce varying amounts of blur at the image sensor 301. This analysis traces the light from single interaction sites 105, 113, 111 to their corresponding blurring patterns at locations 302, 303, 304. As is known in the art, this analysis can also be carried out in the opposite manner, by determining the light path that correspond to a single location on the image sensor 301. This alternative analysis method is illustrated in FIGS. 3A through 3D.

FIG. 3A shows a ray tracing of the light 54 that will that will be sharply focused at a single point on the image sensor 301. As is readily apparent to one skilled in the art, this ray tracing will be parallel between the collimating lens 201 and the focusing lens 203, and be limited in width by the aperture 202. Between the collimating lens 201 and the rear surface 102 of the scintillation crystal 100, the ray tracing 54 is a cone with an angle determined by the focal length of the collimating lens 201. Within the scintillation crystal 100, between the rear face 102 and the focal plane 103, the ray tracing 54 is also a cone. However the angle of this cone is smaller inside of the scintillation crystal 100 than outside. This is due to the index of refraction of the scintillation crystal 100 being greater than the index of refraction of air, as is well know in the art of optical science. Between the focal plane 103 and the front surface of the crystal 101, the ray tracing 54 is also a cone, with its apex positioned on the focal plane 103. As will be appreciated and understood by one skilled in the art, any source of omnidirectional light within the ray tracing 54 will result in a portion of that light being focused to the single point under consideration on the image sensor 301.

Still referring to FIG. 3A, the beam of x-rays (50 in FIG. 1) will enter the scintillation crystal 100 through the front surface 101 and penetrate to an average depth 51. This results in omnidirectional points of light being generated with the scintillation crystal 100 from the front surface 101 to the penetration depth 51. As is known in the art, the penetration of x-rays in a material is an exponentially decaying function; however, the average depth 51 of this penetration is sufficient for one skilled in the art to understand the present Invention. The intersection of this scintillation (from the front surface 101 to depth 51) and the ray tracing 54 is two cone shaped light gathering regions 55. The average width of these light gathering regions 55 is the blurring distance 52. As can be appreciated by one skilled in the art, this blurring distance 52 is a measure of the spatial resolution of the overall x-ray imaging system. That is, the single point under consideration on the image sensor 301 receives light that originates from x-rays 50 that strike the scintillation crystal 100 within the blurring distance 52.

The above description provides an analytical method for determining the spatial resolution of an x-ray detector composed of a scintillation crystal 100, a lens assembly 200, and an electronic camera 300. Further, this method can be used to explain the operation of the Invention and how the Invention achieves far improved spatial resolution over prior art approaches. Using FIG. 3A as a baseline, FIGS. 3B, 3C, and 3D illustrate three ways that the spatial resolution of this configuration can be improved.

As illustrated in FIG. 3B, the blurring distance 52 can be reduced by selecting a scintillation crystal 100 with a higher index of refraction. This results in the cone shaped light gathering regions 55 having a smaller subtended angle, and therefore a smaller average width. FIG. 3C illustrates that the blurring distance 52 can also be reduced by decreasing the size of the aperture 202, that is, using a lens with a higher f-number. This also results in the cone shaped light gathering regions 55 having a smaller subtended angle, and therefore a smaller average width. Further, as shown in FIG. 3D, the blurring distance 52 can also be reduced by making the penetration distance 51 smaller. For a fixed x-ray energy, this can be accomplished by using a scintillation crystal that is more dense, is composed of higher atomic number elements, or both. As illustrated in FIG. 3D, this requires the lens assembly 200 to be adjusted to maintain the focal plane 103 near the center of the penetration depth 51.

Prior art x-ray detectors, such as described in U.S. Pat. Nos. 3,790,785 and 5,723,865, do not take advantage of the above described resolution enhancements, and are therefore incapable of providing spatial resolutions better than 50-100 microns. Specifically, the present Invention achieves 5-10 micron resolution through the use of three modifications, in concert or individually.

First, prior art systems use a scintillation crystal composed of either Sodium Iodide (NaI) or Cesium Iodide. (CsI). The index of refraction of these compounds is 1.85 and 1.79, and their density is 3.67 gm/cc and 4.51 gm/cc, respectively. Further, the highest atomic number present in NaI is Z=53, and in CsI it is Z=55. The present invention uses a scintillation crystal containing a higher atomic number element than prior art systems to achieve improved resolution. In one preferred embodiment, the Invention uses a scintillation crystal composed of Bismuth Germinate Oxide (BGO), with a highest atomic number of Z=83, an index of refraction of 2.15, and a density of 7.2 gm/cc. In another preferred embodiment, the Invention uses a scintillation crystal composed of either Cadmium Tungstate (CdWO4) or Gadolinium Silicate (GSO), with highest atomic numbers Z=74 and Z=64, indexes of refraction of 2.3 and 1.85, and densities of 7.9 and 6.71 gm/cc, respectively.

The present Invention achieves higher spatial resolution than prior art systems by its use of dense and higher atomic number scintillation crystals. The increased atomic number (e.g. Z=83, 74, or 64 versus Z=53 or 55), and the increased density (e.g. 7.2, 7.9 or 6.71 gm/cc versus 3.67 or 4.51 gm/cc) results in the x-ray penetration depth 51 being shortened. This improves the spatial resolution as previously described in conjunction with FIG. 3D. Likewise, the increased index of refraction of the higher atomic number scintillation crystals (e.g., BGO=2.15 and CdWO4=2.3 versus NaI=1.85 and CsI=1.79) results in improved resolution in accordance with FIG. 3B.

Second, prior art systems use a low f-number lens assembly 200, such as f#=0.83 and f#=3.0 in U.S. Pat. Nos. 5,723,865 and 3,790,785, respectively. In contrast, the present Invention achieves improved spatial resolution by using a large f-number, typically in the range f#=4.0 to 16.0. As previously described in conjunction with FIG. 3C, the large f-number results in the narrowing of the cone shaped light gathering regions 55, and the subsequent spatial resolution improvement.

Third, prior art systems teach the use of a light reflecting layer on the front surface 101 of the scintillation crystal 100. This may take the form or a specular reflector, as in U.S. Pat. No. 3,790,785, or a mirror surface, as in U.S. Pat. No. 5,723,865. While this reflecting layer improves the light collection, it reduces the spatial resolution by a factor of at least two. In the present Invention the front surface 101 of the scintillation crystal 100 is coated with a light absorbing layer, such as black paint, thereby providing improved resolution.

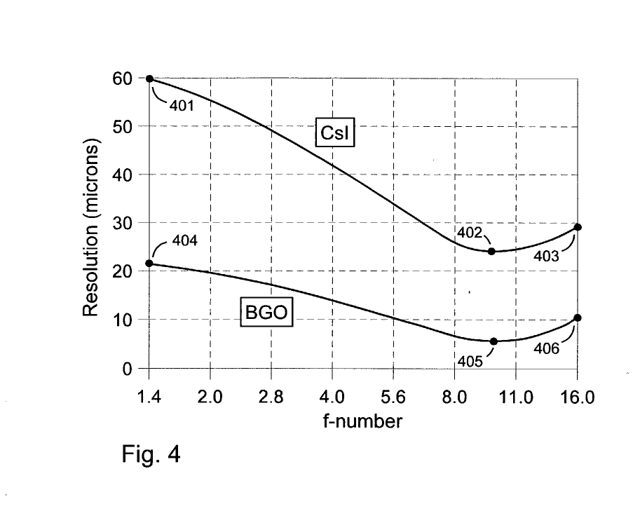

FIG. 4 presents empirical data illustrating the operation and benefit of the present Invention over the prior art. This graph shows the spatial resolution of the detector as a function of f-number and type of scintillation crystal used. The prior art is exemplified by the use of CsI scintillation crystal and an f-number of 1.4. As denoted by the data point 401, the prior art system exhibits a spatial revolution of approximately 60 microns. As indicated by the data point 402, this improves to a spatial resolution of about 24 microns when the f-number is changed to f#=10. This is in accordance with the explanation of FIG. 3C. As the f-number is increased further, such as indicated by the data point 403, the resolution degrades. This is a result of diffraction effects from the very small lens aperture. This curve for CsI is measured with the front surface 101 of the scintillation crystal 100 painted back. If a light reflector were used on this surface, as taught by the prior art, the resolution shown in FIG. 4. would be twice as poor. That is, the exemplary prior art using CsI and f#=1.4 would show a resolution of 120 microns.

The present Invention is exemplified by the curve in FIG. 4 for BGO. As can be readily seen, the use of BGO improves the resolution over CsI by a factor of about three (i.e., data point 401 versus data point 404; 402 versus 405, and 403 versus 406). As previously explained, this would be a factor of about six improvement if the CsI incorporated a reflective front surface. This improvement in resolution is a result of (1) the higher atomic number element contained in BGO versus CsI, (2) the greater density of BGO compared with CsI, and (3) the greater index of refraction of BGO compared to CsI. The atomic number and density differences result in a shorter penetration depth, improving the resolution in accordance with the explanation of FIG. 3D. The difference in index of refraction improves the resolution as explained in FIG. 3B.

As also demonstrated in FIG. 4, the resolution using BGO can be improved by a factor of 3-4 by changing the f-number of the lens from f#=1.4 to f#=10. This is shown by comparing data point 404 with data point 405. As with CsI, increasing the f-number further degrades the resolution due to diffraction effects in the small aperture, as indicated by data point 406.

As clearly shown by the above description and explanations, the present Invention achieves 10 to 20 times the spatial resolution of prior art systems. As shown by the data point 405 in FIG. 4, a preferred embodiment of the Invention using BGO, an f-number of 10, and a light absorbing front entry surface, can achieve 5-10 micron resolution, . In comparison, prior art systems using CsI or NaI, and an f-number less than 3, cannot achieve better than about 50-100 micron resolution.

As can be appreciated by those skilled in the art, prior art systems are designed to maximize light transfer from the scintillation crystal 100 to the camera 300. This is evident in three areas. First, the scintillation crystals used in prior art systems, i.e., NaI and CsI, have the highest scintillation light output of all know crystals, being many times greater than BGO, CdWO4 and GSO. Second, the use of a low f-number lens captures more of the scintillation light. Third, the use of a reflective front surface of the scintillation crystal further increases the light transfer by a factor or two. All told, prior art systems are inherently constructed to maximize the amount of light received by the camera.

As is know in the art, insufficient light transfer can result in a reduced Detector Quantum Efficiency, necessitating a larger x-ray dose to produce the same noise level in the acquired image. This is critically important in medical radiography, where the x-ray dose must be kept as low as possible for health considerations. However, this is not a significant consideration for the present Invention, since x-ray imaging with a resolution of 5-10 microns has little or no application for biological structures. The reason for this is the low attenuation of x-rays in biological tissues. For instance, a biological structure with a diameter of 100 microns will also typically have a thickness of 100 microns. However, a biological tissue thickness of 100 microns has such low contrast in x-ray images that it can cannot be detected, regardless of the spatial resolution of the system. On the other hand, the inspection of electronic solder connections and metal components, a primary use of the inventive system, can easily be accomplished with x-ray imaging, even with object thickness far less than 100 microns.

It can thus be seen that prior art systems are designed for the needs of medical radiography and the examination of biological tissues, by maximizing the light detection to reduce the radiation dose to the patient. As is also apparent to one skilled in the art, this dictates the use of either NaI or CsI scintillation crystals, the use of a low f-number lens assembly, and the use of a reflective layer on the front surface of the scintillation crystal. Taken together, these factors limit the spatial resolution of these systems to about 50-100 microns, which is completely adequate for the examination of biological tissues.

However, prior art systems are inadequate to examine solder connections and other small metal objects, where a spatial resolution of 5-10 microns is often required. The present Invention achieves this resolution by utilizing a dense scintillation crystal containing a high atomic number element, such as BGO, CdWO4 or GSO, with a light absorbing front surface.

In a preferred embodiment, the inventive system also comprises a lens assembly with a high f-number, typically in the range f#=4.0 to 16.

In accordance with the previous descriptions and goals, the preferred embodiment of the present Invention is described as follows. The scintillation crystal 100 is composed of optically transparent BGO, measuring 1 cm×1 cm by 5 mm thick. The front surface 101 of the scintillation crystal 100 is painted with optically black paint, effectively absorbing any light incident on this surface from inside of the scintillation crystal 100. The rear surface 102 of the scintillation crystal 100 is polished to an smooth optical finish. The collimating lens 201 is a commercially available camera lens with a focal length of 25 mm and a c-mount connector, such as commonly used in CCTV applications. The focusing lens is also a commercially available camera lens with a focal length of 50 mm and a c-mount, as also commonly used in CCTV applications. An aperture 202 is provided to limit the diameter of the light path through the lens assembly 200. In the preferred embodiment, the diameter of this aperture is adjusted to be approximately 2.5 mm. This results in the f-number of the lens assembly 200 being equal to the focal length of the collimating lens 201 divided by the diameter of the aperture 202, which in the preferred embodiment is 25 mm/2.5 mm=10. As is apparent to one skilled in the art, aperture 202 can be a stand-alone component located between the scintillation crystal 100 and the collimating lens 201, located between the collimating lens 201 and the focusing lens 203, or located between the focusing lens 203 and the camera 300. Likewise, the aperture 202 can be an integral part of either the collimating lens 201 or the focusing lens 203. In one preferred embodiment, the aperture 202 is an adjustable iris contained within the commercially available focusing lens 203, as commonly used in CCTV applications. In another preferred embodiment, the aperture 202 is an adjustable iris contained within the commercially available collimating lens 201.

In the preferred embodiment, the camera 300 is a Cohu model 4912, with an image acquisition of 768×494 pixels over an active area of 6.4×4.8 mm. The combination of the 25 mm focal length on the collimating lens 201, and the 50 mm focal length on the focusing lens 203, results in a magnification factor of two between the scintillation crystal 100 and the camera 300. Therefore, the size of the x-ray imaging area is 3.2×2.4 mm, with each pixel representing (3.2 mm/768 pixels) 4.17 micron in width and (2.4 mm/494 pixels) 4.86 micron in height. This pixel size of 4.17 by 4.86 micron is small enough to record the 5-10 micron resolution optical image being relayed by the lens assembly without undue degradation. The video signal produced by camera 300 can be displayed on a video monitor, recorded on a video cassette recorder, digitized into a computer format, and/or manipulated in other ways that are well known in the art of video imaging. These components and operations associated with the video signal produced by camera 300 are not a part of the present Invention.

In the preferred embodiment, the above described focusing lens 203 is attached to the camera 300 by a standard c-mount connector, and adjusted to a focal setting of infinity. The above described collimating lens 201 is mounted with its light exit aperture in close proximity, typically a few millimeters, to the light entry aperture of the focusing lens 203. To provide the best possible focusing, the collimating lens 201 is positioned with its c-mount connector toward the scintillation crystal, and away from the focusing lens 203. The front surface 101 of the scintillation crystal 100 is positioned approximately 17.42 mm from the reference surface of the c-mount connector of the collimating lens 201. This places the focal plane 103 of the collimating lens 201 inside the scintillation crystal, approximately 0.1 mm from the front surface 101. Therefore, the focal plane 103 is approximately centered on the depth of penetration 51 of the incident x-rays 50. In this preferred embodiment, the collimating lens 201 is grossly adjusted to a focal setting of infinity, with fine adjustments made as needed to achieve sharp focusing.

In another preferred embodiment, the scintillation crystal 100 is composed of either CdWO4 or GSO. Due to their particular crystalline structure, CdWO4 and GSO exhibit significant birefringence in their optical properties. In other words, the vertical and horizontal polarizations of the light exiting the scintillation crystal 100 are slightly misaligned. If uncorrected, this would result in a double image being produced by the inventive system.

Accordingly, this preferred embodiment incorporates a polarization filter placed in the optical path, thereby eliminating one of the polarizations. Polarization filters of this type are common in the art, such as sold by Edmund Scientific Corporation, Barrington, N.J.

Other embodiments of the Invention will now be described that have applicability to particular applications. In one embodiment, the lens assembly 200 contains one or more adjustable optical elements to change the optical magnification between the scintillation crystal 100 and camera 300. This can be accomplished by using an adjustable zoom lens, such as widely used in CCTV applications, for the focusing lens 203. This allows for the adjustment of the optical magnification of the lens assembly 200, making the size of the x-ray imaging area in the crystal larger or smaller. In another embodiment, a light image amplifier, such as a microchannel plate, may be used to provide a higher level of light to the camera. In yet another embodiment, the camera 300 may be operated in a extended integration mode, allowing for a greater collection of light to form a single image. In yet another embodiment, a right angle mirror may be inserted into the optical path, thereby preventing x-rays that penetrate the scintillation crystal from striking the camera.

While the above description contains many specifications and particulars, the reader should not construe these as limitations on the scope of the invention, but merely as exemplifications of the preferred embodiments thereof. Those skilled in the art will envision many other possible variations within its scope. For instance, the inventive system may be used with x-rays, gamma rays, or similar forms of penetrating radiation. Further, the lens assembly may include manual or motorized adjustments for focusing, magnification, f-number and the like. Still further, the camera may have a greater or fewer number of pixels, and produce an output signal that is analog or digital.

While the Invention has been particularly shown and described with reference to a preferred embodiment thereof, it will be understood by those skilled in the art that various changes in form and details may be made without departing from the spirit and scope of the Invention.

Therefore it is the intention to limit the Invention only as indicated by the scope of the appended claims.

I claim:

1. A high-resolution radiation detector, comprising:
a scintillation crystal for converting a radiation image into a visible light image, said scintillation crystal containing an element of atomic number greater than 55, said scintillation crystal having a density greater than 5 grams per cubic centimeter, said scintillation crystal being optically transparent;
a camera for converting said visible light image into an electronic video signal;
a optical assembly for relaying said visible light image from said scintillation crystal to said camera; and
a light absorbing layer, said light absorbing layer affixed to the radiation entry surface of said scintillation crystal.

2. A high-resolution radiation detector as claimed in claim 1, wherein said scintillation crystal is from the group consisting of Bismuth Germinate Oxide, Cadmium Tungstate, and Gadolinium Silicate.

3. A high-resolution radiation detector as claimed in claim 1, wherein said optical assembly comprises a lens.

4. A high-resolution radiation detector as claimed in claim 2, wherein said optical assembly comprises a lens.

5. A high-resolution radiation detector as claimed in claim 4, wherein said lens has an f-number greater than 3

6. A high-resolution radiation detector as claimed in claim 1, wherein said radiation image comprises an x-ray image.

7. A high-resolution radiation detector as claimed in claim 4, wherein said radiation image comprises an x-ray image.

8. A high-resolution radiation detector as claimed in claim 5, wherein said radiation image comprises an x-ray image.

9. An apparatus for detecting a pattern of radiation, comprising:
scintillator means for creating a pattern of light in response to said pattern of radiation, said scintillator means having a high density and a high atomic number,
optical transfer means for transporting said pattern of light from said scintillator means to a second location;
optical detection means located at said second location for producing an electronic signal representative of said pattern of light; and
light absorbing means affixed to said scintillator means for eliminating reflected light within said scintillator means.

10. An apparatus as claimed in claim 9, wherein said scintillator means is a Bismuth Germinate Oxide crystal.

11. An apparatus as claimed in claim 9, wherein said scintillator means is a transparent crystal from the group consisting of Cadmium Tungstate and Gadolinium Silicate.

12. An apparatus as claimed in claim 9, wherein said optical transfer means comprises a lens.

13. An apparatus as claimed in claim 10, wherein said optical transfer means comprises a lens.

14. An apparatus as claimed in claim 13, wherein said lens has an f-number greater than 3.

14. An apparatus as claimed in claim 10, wherein said pattern of radiation comprises a pattern of x-ray radiation.

15. An apparatus as claimed in claim 13, wherein said pattern of radiation comprises a pattern of x-ray radiation.
